(19) United States
(12) Patent Application Publication
(10) Pub. No.: US 2025/0264035 A1
(43) Pub. Date: Aug. 21, 2025

(54) MEASUREMENT OF A RADIAL GAP IN A GAS TURBINE ASSEMBLY

(71) Applicant: MTU Aero Engines AG, München (DE)

(72) Inventors: Juergen Gruendmayer, Wolfratshausen (DE); Josef Weber, Aichach (DE)

(73) Assignee: MTU Aero Engines AG, München (DE)

(21) Appl. No.: 19/055,124

(22) Filed: Feb. 17, 2025

(30) Foreign Application Priority Data
Feb. 20, 2024 (DE) 10 2024 104 748.8

(51) Int. Cl. F01D 21/00

(52) U.S. Cl. CPC F01D 21/003; F05D 2270/8041

(57) ABSTRACT

The present invention relates to a method for the measurement of a radial gap between a housing section of a gas turbine assembly and, arranged in the housing section, a rotor section of a rotor of the gas turbine assembly by means of a measurement system, which is fastened to the rotor section and has an illumination device and a receiver, wherein the method has the step of illuminating the housing section and detecting the radiation reflected from the housing section; and the multiply repeated steps of shifting the rotor to a further rotational position; and illuminating the housing section and detecting the radiation reflected from the housing section; as well as the step of determining a radial gap size between the housing section and the rotor section on the basis of the detected reflected radiation.

### BACKGROUND OF THE INVENTION

The present invention relates to a method, a measurement system, and a measurement setup for the measurement of a radial gap between a housing section of a gas turbine assembly and, arranged in the housing section, a rotor section of a rotor of the gas turbine assembly.

### SUMMARY OF THE INVENTION

An object of one embodiment of the present invention is to improve a measurement of a radial gap between a housing section of a gas turbine assembly and, arranged in the housing section, a rotor section of a rotor of the gas turbine assembly.

This object is achieved by a method and a measurement system or a measurement setup for the implementation of a method described herein.

In accordance with one embodiment of the present invention, an assembly for a gas turbine, preferably an assembly of a gas turbine, preferably an assembly having one compressor stage or a plurality of compressor stages and/or one turbine stage or a plurality of turbine stages for the gas turbine or of the gas turbine, has a housing section and, arranged in this housing section, a rotor section of a rotor of the gas turbine assembly.

In one embodiment, the gas turbine (assembly) is an aircraft engine gas turbine (assembly). In one embodiment, the rotor section has at least one section of at least one rotating blade and, in particular, can be a rotating blade section. Additionally or alternatively, the rotor section is a radially outer rotor section or a rotor section that faces the housing section or lies (radially) opposite to the housing section, that is, in particular, a radially outer rotating blade section that faces the housing section or lies (radially) opposite to the housing section. On account of the conditions and requirements for a measurement, the present invention is especially suitable for this purpose.

In the present case, an axial direction is preferably parallel to a rotational axis of the rotor or the (main) machine axis of the gas turbine (assembly), a circumferential direction is a rotational direction around this rotational axis or (main) machine axis, and a radial direction is perpendicular to the axial direction and circumferential directions, preferably pointing away from the rotational axis.

In accordance with one embodiment of the present invention, a measurement system, which is set up and is used for the preferably spatially resolved measurement of a radial gap between the housing section and the rotor section, can be fastened to the rotor section in a detachable manner, preferably temporarily and/or without destruction of the measurement system (“free of measurement system destruction”), and, in a further development, is fastened in a detachable manner, preferably temporarily and/or without destruction of the measurement system (“free of measurement system destruction”), and has an illumination device and a receiver.

In accordance with one embodiment of the present invention, a method for the preferably spatially resolved measurement of a radial gap between the housing section and the rotor section by a measurement system described here, which is fastened to the rotor section, preferably temporarily and/or can be detached without destroying the measurement system, has the step of:
illuminating the housing section by the illumination device and 3
detecting the radiation reflected from the housing section by the receiver in a first rotational position of the rotor;
and the multiply repeated steps of:
shifting the rotor to a further rotational position; and
illuminating the housing section by the illumination device and detecting the radiation reflected from the housing section by the receiver in this further rotational position of the rotor;
as well as the step of:
determining a radial gap size between the housing section and the rotor section, in particular for the respective rotational position, on the basis of the detected reflected radiation.

This is based, in particular on the idea of optically determining the radial gap size in the various rotational positions and thus advantageously in a smooth and/or precise and/or fast manner. In one embodiment, in the case of one or more pairs of adjacent rotational positions in the circumferential direction, the two rotational positions of the respective pair have an angular offset of at most 5°, preferably at most 2°, with respect to each other. Additionally or alternatively, in one embodiment, the rotational positions are distributed equidistantly. Additionally or alternatively, when the rotor is shifted into its rotational position, the rotor is turned
manually or by a motor; and/or
continuously or intermittently; and/or
in total by at least 355°, preferably at least 358°.
   In this way, it is possible in each instance, in particular by combining two or more of these features, to realize an especially advantageous, in particular rapid, simple, precise, and/or reliable measurement.

In one embodiment, the receiver can have at least one camera and, in particular can be a camera and
the illumination of the housing section comprises in each instance a light projection of an illumination pattern, which preferably has one or more preferably straight line(s) and, in particular can be composed thereof, onto the housing section by the illumination device;
the detection of the radiation reflected from the housing section comprises in each instance a recording of an image of the illumination pattern (projected on the housing section by the illumination device) by the camera; and
the determination of the radial gap size comprises determining the radial gap size on the basis of the recorded images.

In other words, in this embodiment, the method has the step of:
light projection of the illumination pattern by the illumination device and recording of an image of this illumination pattern by the camera in a first rotational position of the rotor or in the first rotational position of the rotor;
and the multiply repeated steps of:
shifting the rotor to a further rotational position; and
light projection of the illumination pattern by the illumination device and recording of an image of the illumination pattern by the camera in this further rotational position of the rotor;
   as well as the step of:
determination of a radial gap size between the housing section and the rotor section, in particular for the respective rotational position, on the basis of the recorded images.

By this (camera) variant, it is possible in one embodiment to determine the radial gap size especially advantageously, in particular in a precise, simple, and/or fast manner.

In one embodiment, a time between the preferably pulsed or intermittent illumination of the housing section by the illumination device and the detection of the radiation reflected from the housing section is detected in each instance, with the determination of the radial gap size preferably comprising a determination of the radial gap size, in particular for the respective rotational position, on the basis of these propagation times. In other words, the radial gap size in this (Lidar) variant is determined by a Lidar method.

In one embodiment, by this (Lidar) variant, it is possible to determine the radial gap size likewise very advantageously, in particular in a precise, simple, and/or fast manner. In this case, the camera variant can be, in particular, a (more) compact, (more) interference-free, and/or (more) autonomous measurement system and/or make possible a simple (simpler) measurement, the Lidar variant offering, in particular, an especially precise measurement.

In one embodiment, the measurement system that is fastened to the rotor section has a sensor device, by which, in particular a one-dimensional, two-dimensional, or three-dimensional or higher-dimensional pose—in one embodiment a six-dimensional pose—of the measurement system, in particular in the respective rotational position or positions, and/or the (respective) rotational position or positions of the rotor is or are determined or is or are set up or used for this purpose. In one embodiment, the sensor device has at least one acceleration sensor and/or at least one gyroscope.

In one embodiment, the poses or rotational positions determined in this way are used in the illumination of the housing section and/or in the detection of the radiation reflected and/or in the determination of the radial gap size. This can comprise, in particular, the fact that the illumination of the housing section and/or the detection of the radiation reflected from the housing section in the respective rotational position on the basis of the poses and/or rotational positions determined in this way is triggered or carried out and/or the poses and/or rotational positions determined in this way and the measurements, in particular, that is, the recorded images or determined propagation times, are assigned to one another in the respective rotational positions in the determination of the radial gap size.

Additionally or alternatively, in one embodiment, the measurement system fastened to the rotor section has an energy storage unit, which supplies electric energy to the measurement system, preferably to
the illumination device; and/or
the receiver, which, in a further development, is the camera; and/or
the sensor device for the determination of a pose of the measurement system and/or of a rotational position of the rotor; and/or
the computing unit and/or memory storage device mentioned below,
   at least temporarily, preferably at least during the illumination of the housing section by the illumination device and/or during the detection of the radiation reflected from the housing section by the receiver, in particular the recording of an image of the illumination pattern by the camera, and/or the processing and/or memory storage of signals detected by the receiver by the computing unit or memory storage device, so that the measurement system is (energy) autonomous, or which is set up or used to this end.

Additionally or alternatively, in one embodiment, the measurement system fastened to the rotor section has an above-mentioned computing unit or the above-mentioned computing unit, which controls:
the illumination device; and/or
the receiver, which, in a further development, is the camera; and/or
the sensor device for the determination of a pose of the measurement system and/or of a rotational position of the rotor; and/or
the memory storage of signals detected by the receiver
   and/or preferably, while the measurement system is still fastened to the rotor section, processes signals detected by the receiver by the images recorded in one embodiment by the camera, or which is set up or is used for this purpose.

Additionally or alternatively, in one embodiment, the measurement system fastened to the rotor section has a memory storage device, which saves signals detected by the receiver by the images recorded in one embodiment by the camera and/or a result of a processing of the signals that are detected by the receiver—in one embodiment, by the images recorded by the camera—by the computing unit, preferably together with these assigned poses of the measurement system and/or rotational position of the rotor determined by the sensor device, or which is set up or is used for this purpose.

In this way, it is possible in each instance, in particular by combining two or more of these features, to realize especially advantageously an autonomous measurement system or measurement.

In one embodiment, prior to the detection of the reflected radiation without destruction of the measurement system, the measurement system in a further development is fastened magnetically and/or by detachable adhesive connection and/or mechanically, such as, for example, by clamping and/or by fastening to a rotating blade of the rotor and/or, after the detection of the reflected radiation, is removed from the rotor section preferably without destruction of the measurement system and/or is withdrawn through an opening of the housing section.

In this way, it is possible advantageously to reduce any interference of a test operation of the gas turbine assembly and/or to (re) use the measurement system multiple times and thus to reduce cost and/or material expenditure.

In accordance with a preferred aspect of the invention, the measurement system is fastened detachably to a rotating blade or to a stator vane or to a housing section and/or is removed from it by way of a boroscope opening or the like, in particular by a boroscope.

In this way, it is possible for the measurement system to be employed in the assembled state of the gas turbine assembly, in particular in an operable gas turbine, and then to be removed again, whereas systems known from the prior art can often be fastened only to fan blades that are readily accessible from the outside.

In one embodiment, the illumination device has at least one laser. In this way, it is possible, in particular in the camera variant, to project the illumination pattern (more) precisely or, in the Lidar variant, to clock the pulsed or intermittent illumination (more) precisely and/or to determine the propagation time(s) more precisely, and, in each instance, thereby to improve the precision of the measurement.

In one embodiment, the measurement system has a housing, in which the illumination device and the receiver—in a further development, also the sensor device and/or the energy storage unit and/or the computing unit and/or the memory storage device—are arranged and/or which has a maximum dimension of at most 5 cm, preferably at most 3 cm. In this way, in one embodiment, it is possible in the manner of a so-called Pillcam to use an especially compact and/or protected measurement system and thereby to improve the measurement; in particular, this makes possible the assembly/disassembly of the system through a boroscope opening.

In one embodiment, preferably of the camera variant, the receiver of the measurement system that is fastened to the rotor section has (the) at least one camera, by which at least one image of a portion of the rotor section, preferably of an edge on the housing section side of the rotor section, or of a calibration device that is temporarily placed on the rotor section, such as, for example, a calibration angle or the like, is recorded and the measurement system is calibrated on the basis of this image. In one embodiment, on the basis of the (different) positions of the illumination pattern in the recorded images, it is possible to determine a change in the radial gap. In particular, by way of the additional calibration on the basis of an image of a portion of the rotor section or of a calibration device that is temporarily placed on the rotor section, it is possible, in addition, to determine an (absolute) radial gap between the rotor section and the housing section. Accordingly, it is possible for a radial gap size in the sense of the present invention to specify, in particular, a radial gap and/or the change thereof, preferably for the (respective) rotational position(s).

In a further embodiment that, if need be, is independent of the claimed embodiment, the receiver and the illumination device of the measurement system are set up to carry out a 3D scan method. For example, this could be carried out by way of fringe projection, whereby, in this case, the illumination device would be a projector that is set up to project structured light and the receiver would be one camera or a plurality of cameras that makes or make recordings of the structured light at a predetermined angle. Alternatively, the 3D scan method could also be, for example, a laser scanning method. In such an embodiment of the measurement system using a 3D scan method, the measurement system can comprise at least one camera system for conventional imaging and can be set up to project these image data by a computing unit of a microcontroller onto the 3D data detected using the 3D scan method in order to obtain a complete image of the engine interior. In such a method, in which a 3D scan method is employed, the measurement system can either be fastened to a rotating blade and record images of housing sections or other stationary structures or else be fastened to a housing section or a stator section and record images of a (stepwise) rotating rotor.

In accordance with one embodiment of the present invention, a measurement setup has a gas turbine assembly described herein and a measurement system described herein, by which a method described herein is carried out or a measurement system described herein or a measurement setup described herein is used for carrying out a method described herein.

In one embodiment, one step or a plurality of steps, in particular all steps, of the method is or are computer-implemented in full or in part or one step of the method or a plurality of steps of the method, in particular all steps of the method, is or are carried out in a fully or partially automated manner, in particular by the measurement system.

### BRIEF DESCRIPTION OF THE DRAWING FIGURES

Further advantageous enhancements of the present invention ensue from the dependent claims and the following description of preferred embodiments. Shown herein for this purpose in a partially schematic manner:

FIG. 1 shows a measurement setup in accordance with one embodiment of the present invention having a rotor for a measurement of a radial gap in a first rotational position;

FIG. 2 shows the measurement setup in a further step of a measurement of the radial gap in accordance with an embodiment of the present invention with the rotor in a further rotational position; and

FIG. 3 is a side view, which shows how a measurement system in accordance with the present invention is fastened to a rotating blade through a boroscope boss by a boroscope.

### DESCRIPTION OF THE INVENTION

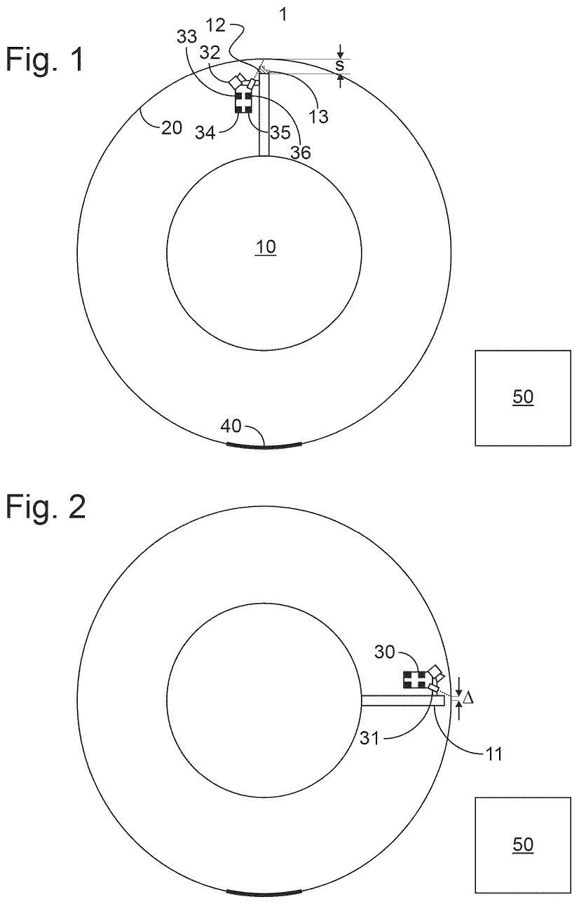

FIG. 1 shows a measurement setup in accordance with an embodiment of the present invention with a rotor 10 of a gas turbine assembly arranged in a housing section 20 during a measurement of a radial gap s between a rotor section, arranged in the housing section 20, in the form of a rotating blade 11 (see FIG. 2) of the rotor 10 by a measurement system in accordance with one embodiment of the present invention for a spatially resolved measurement of the radial gap in accordance with one embodiment of the present invention, with the rotor 10 in FIG. 1 having a first rotational position. Further rotating blades of the rotor, such as, for example, of a compressor or turbine stage or a plurality of compressor or turbine stages, are not depicted for reasons of better overview.

Prior to the step of the method explained below on the basis of FIG. 1, the autonomous measurement system is or will be fastened, without any destruction of the measurement system, preferably magnetically or by detachable adhesive connection, to the rotating blade 11 and, after the last of the steps of the method explained on the basis of FIG. 2, removed from the rotor section or the rotating blade 11 and withdrawn through a boroscope opening 40 of the housing section 20.

A housing 30 of the measurement system includes an illumination device, which, in the exemplary embodiment, is a line laser 31 (see FIG. 2), and a receiver, which, in the exemplary embodiment, is a camera 32 (see FIG. 1).

For the determination of a pose of the measurement system and (from it) a rotational position of the rotor, the housing 30 further includes a sensor device, which, in the exemplary embodiment, is in the form of an inertial measurement device 33, which, in the exemplary embodiment, has a 6 DOF sensor or an acceleration sensor and a gyroscope (see FIG. 1).

The housing 30 further includes a computing unit, which, in the exemplary embodiment, is a microcontroller 34, for the processing of signals detected by the receiver or of images recorded by the camera 32, and a memory storage (device), which, in the exemplary embodiment, is a memory card 35, for saving signals detected by the receiver or images recorded by the camera 32, as well as an energy storage unit, which, in the exemplary embodiment, is a rechargeable battery 36 (see FIG. 1).

The measurement system will be or is fastened to the blade 11 in such a way that the camera 32 and the laser 31 are directed at the housing section 20. The laser is adjusted at an oblique angle to the camera, so that the site of impingement of the laser line depends on the distance of the housing section from the measurement device.

The rotor is then rotated. At specified angular distances, the laser 31 is briefly switched on and an image is recorded by the camera 32 and saved on the memory card 35. The triggering of the laser and the recording of the image at specified angular distances can take place and can be triggered by the sensor device 33 and/or a pose of the measurement system and/or a rotational position of the rotor determined by the sensor device 33 can be saved together with the respective image and used in the determination of the radial gap size.

After a full rotation of the rotor 10 by 360°, the measurement system is removed once again through the boroscope opening 40, preferably by a (hook on the end of a) boroscope (not depicted) and the images are analyzed on a PC 50.

As the comparison of the two rotational positions of FIG. 1, 2 illustrates or as is indicated in FIG. 2 by the shift A, the position of the illumination pattern or of the projected line within the respective image changes in accordance with a change in the radial gap s, so that, through the analysis of the images, a change in the radial gap s can be determined. The assignment of the respective radial gap size to the respective rotational position can thereby ensue, for example, in that a corresponding bit of sensor information of the inertial measurement device 33 is also saved. Additionally or alternatively, the inertial measurement device 33 can also be utilized to record the images in corresponding rotational positions.

FIG. 1 illustrates a step of the method, in which, in a first rotational position of the rotor 10, the housing section 20 is illuminated by the illumination device 31 and, from the radiation reflected from the housing section and detected by the receiver, an image of the illumination pattern projected by the laser 31 is recorded by the camera 32.

FIG. 2 illustrates a further step of the method, in which, in one (of a plurality of) further rotational position(s) of the rotor 10 (in each instance), the housing section 20 is illuminated by the illumination device 31 and the radiation reflected by the housing section 20 is detected by the receiver and an image of the illumination pattern projected by the laser 31 is recorded by the camera 32.

In addition, FIG. 1 highlights a step of the method in which, by the camera 32, an image of an edge 12 of the rotating blade on the housing section side is recorded and the measurement system is calibrated on the basis of this image, such as, for example, on the basis of the position and size of the edge in this image.

In the present disclosure, “has an X” implies, in general, not a final numerical count, but rather is a short form of “has at least one X” and also comprises “has two or more X” as well as “also has Y in addition to X.” Although, in the preceding description, exemplary embodiments were explained, it is noted that a large number of modifications are possible.

Thus, in particular, when the edge 12 of the rotating blade 11 is not in the camera image or is not captured by the camera, instead of it, the calibration makes use of a calibration angle 13 that is temporarily placed on the rotating blade, such as indicated cross-hatched in FIG. 1.

In the preceding discussion, a camera variant was explained. In an alternative Lidar variant, the laser 31 in the respective rotational position emits laser impulses and the Lidar receiver 32 detects the light that is reflected by the housing section. From the propagation time of the light signals, the distance or the radial gap size is calculated by the computing unit 34, for example. Likewise, the propagation times can also be saved on the memory card and subsequently analyzed externally on a PC 50, for example.

In another embodiment, the autonomous measurement unit (ca. 8 mm×20 mm) includes a plurality of cameras, a line laser, an inertial measurement device, a microcontroller, and a memory storage unit, as well as a rechargeable battery. The measurement device is fastened on a rotating blade (that is, on the rotor) by a detachable adhesive connection or else magnetically, so that the camera and the laser are directed at stators. Alternatively, by the same technique, the measurement unit is fastened on the housing or on a stator part and directed at a rotor. The laser generates a plurality of lines or a pattern, which are or is oriented at an oblique angle to the camera, so that the site of impingement of the laser lines depends on the distance separating the blade and the stators.

At a specific angular distance, the laser is switched on briefly and an image is saved. From these images, it is possible to compute a 3D model of the engine interior. Additionally, it is possible also to take “normal” photos. These image data can be projected onto the 3D data in order to obtain a complete image of the engine interior.

After the measurement, that is, after the full rotation of the rotor, the measurement device can be removed once again through an existing boroscope opening (for example, by hook at the end of a boroscope) and the images can be analyzed on the PC. Accordingly, accuracies on the order of magnitude of 10 μm can be achieved.

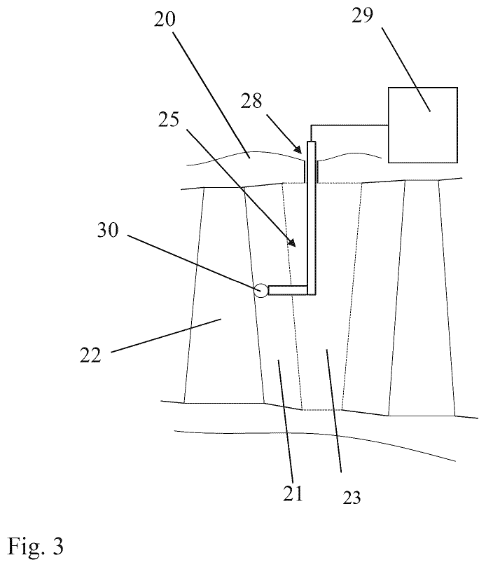

FIG. 3 shows a side view that is rotated by 90° with respect to FIGS. 1 and 2, in which it can be seen how, by a boroscope 25, a measurement system (in the housing 30) is introduced into a gas turbine assembly (in this case, a fully mounted gas turbine). The boroscope 25 is controlled by a boroscope control device 29 and introduced, together with the measurement system, through the boroscope boss 28 into the interior of the housing section 20. A boroscope boss 28 is an opening in the housing 20 that is provided for inspection and, during operation, can be closed with a plug. In this way, the measurement system can be mounted by the boroscope in a gas turbine (or also on a test stand), without the necessity of first disassembling it. The measurement system can be fastened in a detachable manner to a rotating blade 22 or else to a stator vane 23 or to an inner-lying housing section and also can be removed once again through the boroscope opening 28.

In addition, it is noted that the exemplary embodiments only involve examples that are not intended to limit in any way the protective scope, the applications, and the structure. Instead, the person skilled in the art is afforded a guideline by the preceding description for the implementation of at least one exemplary embodiment, whereby it is possible to make diverse changes, in particular in regard to the function and arrangement of the described components without leaving the protective scope, as it ensues from the claims and combinations of features equivalent to these.

1. A method for the measurement of a radial gap between a housing section of a gas turbine assembly and, arranged in the housing section, a rotor section of a rotor of the gas turbine assembly, by a measurement system, which is fastened to the rotor section and has an illumination device and a receiver comprising the steps of:
illuminating the housing section by means of the illumination device and detecting the radiation reflected from the housing section by means of the receiver in a first rotational position of the rotor;
and the multiply repeated steps of:
shifting the rotor to a further rotational position; and
illuminating the housing section by means of the illumination device and detecting the radiation reflected from the housing section by means of the receiver in this further rotational position of the rotor; and
determining a radial gap size between the housing section and the rotor section on the basis of the detected reflected radiation.

2. The method according to claim 1, wherein
the receiver has at least one camera;
the illumination of the housing section comprises in each instance a light projection of an illumination pattern onto the housing section by the illumination device;
the detection of the radiation reflected from the housing section comprises in each instance a recording of an image of the illumination pattern by the camera; and
the determination of the radial gap size comprises a determination of the radial gap size on the basis of the recorded images.

3. The method according to claim 1, wherein, in each instance, a time between the illumination of the housing section by the illumination device and the detection of the radiation reflected from the housing section is recorded and the determination of the radial gap size comprises a determination of the radial gap size on the basis of these propagation times.

4. The method according to claim 1, wherein the measurement system fastened to the rotor section has a sensor device and a pose of the measurement system and/or a rotational position of the rotor are determined by the sensor device and are used for the illumination of the housing section and/or the detection of the radiation reflected from the housing section and/or the determination of the radial gap size.

5. The method according to claim 1, wherein the measurement system fastened to the rotor section has
an energy storage unit, which supplies the measurement system with electrical energy; and/or
a computing unit, which controls the illumination device and/or the receiver and/or the sensor device and/or processes signals detected by the receiver; and/or
a memory storage device, which saves the signals detected by the receiver; and/or are a result of a processing of signals detected by the receiver.

6. The method according to claim 1, wherein, prior to detecting the reflected radiation, the measurement system is fastened without destruction of measurement system and/or on a rotating blade of the rotor and/or, after detecting the reflected radiation, is removed from the rotor section and/or is withdrawn through an opening of the housing section.

7. The method according to claim 1, wherein the illumination device has at least one laser and/or the measurement system has a housing (30), in which the illumination device and the receiver are arranged and/or which has a maximum dimension of at most 5 cm.

8. The method according to claim 1, wherein the measurement system is inserted through a boroscope opening in the housing section or is guided through in an adjacent housing section of the gas turbine assembly to fasten it to the rotor section.

9. The method according to claim 1, wherein the receiver of the measurement system that is fastened to the rotor section has at least one camera, by which at least one image of a portion of the rotor section or of a calibration device temporarily placed on it is recorded and the measurement system is calibrated on the basis of this image.

10. A measurement system for the measurement of a radial gap size between a housing section of a gas turbine assembly, and, arranged in the housing section, a rotor section of a rotor of the gas turbine assembly, the system is fastened to the rotor section, has an illumination device and a receiver, and is configured and arranged for carrying out the steps of illuminating the housing section and detecting the radiation reflected from the housing section of the method according to claim 1.

11. A measurement apparatus, having a gas turbine assembly and a measurement system for the measurement of a radial gap size between a housing section of the gas turbine assembly and, arranged in the housing section, a rotor section of a rotor of the gas turbine assembly, which apparatus is configured and arranged for carrying out a method according to claim 1.
